(19) United States
(12) Patent Application Publication
(10) Pub. No.: US 2003/0050904 A1
(43) Pub. Date: Mar. 13, 2003

(54) Scaling of similarity measures for a biometric method

(75) Inventors: Wolfgang Kuepper, Muenchen (DE); Matthias Schuster, Muenchen (DE)

Correspondence Address: STAAS & HALSEY LLP, 700 11TH STREET, NW, SUITE 500, WASHINGTON, DC, 20001, US

(73) Assignee: Siemens AG.

(21) Appl. No.: 10/188,373

(22) Filed: Jul. 3, 2002

(30) Foreign Application Priority Data
Jul. 3, 2001 (DE) 101 32 012.4

(51) Int. Cl. G06N 5/02

(52) U.S. Cl. 706/48

(57) ABSTRACT

The invention relates to a method for scaling similarity measures for a biometric method, the similarity measures being measures of the similarity of biometric data, to be compared in the biometric method, of a user with reference data of users. The similarity measures are scaled with the aid of mean value scaling.

### CROSS REFERENCE TO RELATED APPLICATIONS

This application is based on and hereby claims priority to German Application No. 101 32 012.4 filed on Jul. 3, 2001, the contents of which are hereby incorporated by reference.

### BACKGROUND OF THE INVENTION

1. Field of the Invention

The invention relates to a method for scaling similarity measures for a biometric method, and to a system and a program product for executing the method.

2. Description of the Related Art

Biometric methods can be applied to authenticate users, that is to say the user is recognized by bodily features or characteristic modes of behavior. Typical biometries are, for example, speaker, signature, hand geometry, fingerprint, iris or face recognition. Biometric methods are disclosed, for example, in the form of dynamic signature verifications in WO 98/24051, WO 98/25228, WO 98/50880, WO 99/08223, in the form of a speaker verification in DE 19952049 A1, and as methods for hand recognition or for determining the position of a hand in U.S. Pat. No. 533,177, U.S. Pat. No. 5,751,843, U.S. Pat. No. 5,828,779, EP 0 560 779 B1, EP 0 713 592 B1, EP 0 800 145 A2 and WO 98/38533.

In all biometric methods, reference and test features are compared with one another via the associated reference and test data and a decision is taken with the aid of similarity measures as to whether they originate from the same user. Similarity measures are, for example, distances, so-called costs, between reference and test features or patterns, or so-called scores that constitute a measure of the probability that the reference and test features originate from the same user. The value range of the costs lies between zero and a certain maximum value, low costs corresponding to high similarity, and high costs to low similarity. The values of the scores lie in the range between zero and one. Scores of one stand for maximum correspondence, and scores of zero for minimum correspondence. Two different cost/score distributions are distinguished: the distributions of the originals to be recognized (genuine distribution) and the impostors (impostor distribution), which should be rejected.

The values of the costs/scores that are generated by the originals and the impostors can be distributed very differently in the case of different users. These different distributions are to be ascribed to various reasons:

quality of the original: ability of the user to reproduce the reference

variance in the type of test data (for example length of signature in the case of signature verification, password in the case of speaker verification)

quality of the impostors

algorithm of the cost calculation.

In the case of the totality of these user-specific cost/score distributions, a global threshold value for a biometry leads to relatively poor results or high error rates (false acceptance rate FAR, false rejection rate FRR, equal error rate EER).

In order to minimize these error rates, the calculated user-dependent costs/scores can be normalized in a user-specific fashion to an overall or common value range such that a global threshold value can continue to be used for this biometry. The use of user-specific threshold values also corresponds in principle to this method, the normalization parameters being included here in the threshold values or their calculation. In this case, the user-specific threshold values are stored instead of the user-dependent normalization parameters and a global threshold.

The aim of a user-specific cost/score normalization is to map the cost/score distributions of the originals and of the impostors as effectively as possible onto one another in order to be able to separate the originals and impostors from one another as effectively as possible by a global threshold. Since, however, only the cost/scores of the originals are available in practice, it is only these values that can be used to carry out normalization capable of being implemented in practice. The cost normalization has previously been undertaken by mean value displacement and/or normalizing by standard deviation, for example by Bruneli, R. and Falavigna, D. “Person Identification Using Multiple Cues”, IEEE Transactions on Pattern Analysis and Machine Intelligence, Vol. 17, No. 10, 1995.

The costs of the originals lie in different value ranges depending on the user. In the case of the normalizing method of mean value displacement, these mean cost values for all users are mapped by a cost displacement onto the same global mean cost value:

K_{normalized}=Kᵤₛₑᵣ+(\overline{K}_{global}−\overline{K}ᵤₛₑᵣ)

where

K_{normalized}: normalized user costs,

Kᵤₛₑᵣ: unnormalized user costs,

\overline{K}ᵤₛₑᵣ: mean value of the unnormalized user costs,

\overline{K}_{global}: mean value of the normalized user costs.

The normalization of the scores can be carried out similarly.

During the mean, value displacement and normalization with the aid of standard deviation, the costs are rendered average-free and normalized by the variance of the respective user costs:

$${K}_{normalized} = \frac{{K}_{user} - {K}_{user} )}{{σ}_{user}}$$

where

σᵤₛₑᵣ: is the variance or standard deviation of the unnormalized user costs.

The normalization of the scores can be carried out similarly here, as well.

Examples show that in the case of normalization by displacing the mean values of the costs or scores of the originals the improvement in the error rates is not as great as in the case of an additional normalization by standard deviation. However, since in practice there are frequently only very few reference features available, the standard deviations as less reliable than the mean values.

### SUMMARY OF THE INVENTION

It is an object of the invention to develop a method for scaling the similarity measures in the case of which the outlined disadvantages are avoided.

This object is achieved by a multimodal biometric method, a system and a program product having the features of the independent claims.

In a method according to the present invention, the similarity measures are scaled with the aid of mean value scaling. For this purpose, the mean values of the costs of all users are firstly calculated to form a common global mean value of the similarity measures of all users. The scaling factor in the case of mean value scaling is then this global mean value of the similarity measures of all users divided by the mean value of the similarity measures of the respective user. The scaled similarity measures of the respective user result, finally, from the multiplication of the unscaled similarity measures of the respective user by this scaling factor.

It is also possible to dispense with calculating the mean values of the costs of all users in relation to a common global mean value of the similarity measures of all users, since this scaling scales only the mean value of one to the mean value for all users. In this case, calculation and storage of the common global mean value are no longer necessary.

Consequently, a method according to the invention for scaling similarity measures requires only the use of the mean values of the similarity measures, but not, by contrast, the standard deviations. Good results are achieved in the case of the error rates, nevertheless, as is shown further below by an example.

The similarity measures of the originals are not mapped onto one another by displacing, but by scaling the mean values. The standard deviation is not incorporated in the scaling. The method is therefore less sensitive in the case of a small number of the similarity measures available for the scaling. Moreover, the calculation and storage of the standard deviations are also no longer necessary. A method according to the invention is therefore, firstly, less complex, since the standard deviation need not be calculated, and also leads to lower error rates than those previously used.

If no further conversions of the scaled similarity measures are undertaken, already normalized similarity measures are obtained according to the above method. This is advantageous, in particular, for comparing and calculating different similarity measures, for example in the case of multimodal biometries.

The similarity measures preferably include or are costs and/or scores.

A system that is set up to execute one of the outlined methods can be implemented, for example, by appropriately programming and setting up a computer or a computer system having the basic components illustrated in FIG. 12.

A program product for a data processing system that includes software code sections with the aid of which one of the outlined methods can be executed on the data processing system can be executed by suitably implementing the method in a programming language and translating into code that can be executed by the data processing system. The software code sections are stored for this purpose. A program product is understood in this case as the program as a product that can be traded. It can be present in any desired form such as, for example, on paper, a computer readable data medium or distributed over a network.

Further substantial advantages and features of the invention follow from the description of an exemplary embodiment with the aid of the drawing, in which:

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a graph of cost distributions of the originals and impostors for a first user;

FIG. 2 is a graph of cost distributions of the originals and impostors for a second user;

FIG. 3 is a graph of unnormalized cost distributions of the originals and impostors for a plurality of users (sum of the individual cost distributions);

FIG. 4 is a graph of resulting error rates for global threshold values without normalization for a plurality of users;

FIG. 5 is a graph of the cost distribution in the case of mean value displacement for a plurality of users;

FIG. 6 is a graph of the error rates in the case of mean value displacement for a plurality of users;

FIG. 7 is a graph of the cost distribution in the case of mean value displacement and scaling with the aid of standard deviation for a plurality of users;

FIG. 8 is a graph of the error rates in the case of mean value displacement and scaling with the aid of standard deviation for a plurality of users;

FIG. 9 is a graph of the cost distribution in the case of mean value scaling for a plurality of users;

FIG. 10 is a graph of the error rates in the case of mean value scaling for a plurality of users and

FIG. 11 is a graph of a Receiver Operating Characteristic (ROC) diagram with and without normalization for a plurality of users.

FIG. 12 is a block diagram of a computer system to which the present invention can be applied.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A method according to the invention for scaling similarity measures in the form of costs/scores uses the mean values of the similarity measures of the originals in order to map the similarity measures onto one another.

The normalization of costs may be explained with an example. The mean values of the costs of all users are firstly calculated to form a common global mean cost value. The normalization factor of the costs of the respective user is then the global mean value of the costs of all users divided by the mean value of the costs of the respective user:

$${K}_{normalized} = \frac{{K}_{user} \cdot {K}_{global} )}{{σ}_{user}}$$

Tests with the aid of exemplary biometries have shown that this method delivers better results than the normalization methods, presented above, employing mean value displacement and/or normalization by standard deviation. This method still achieves very low error rates even with only very few available references that are used exclusively for normalization.

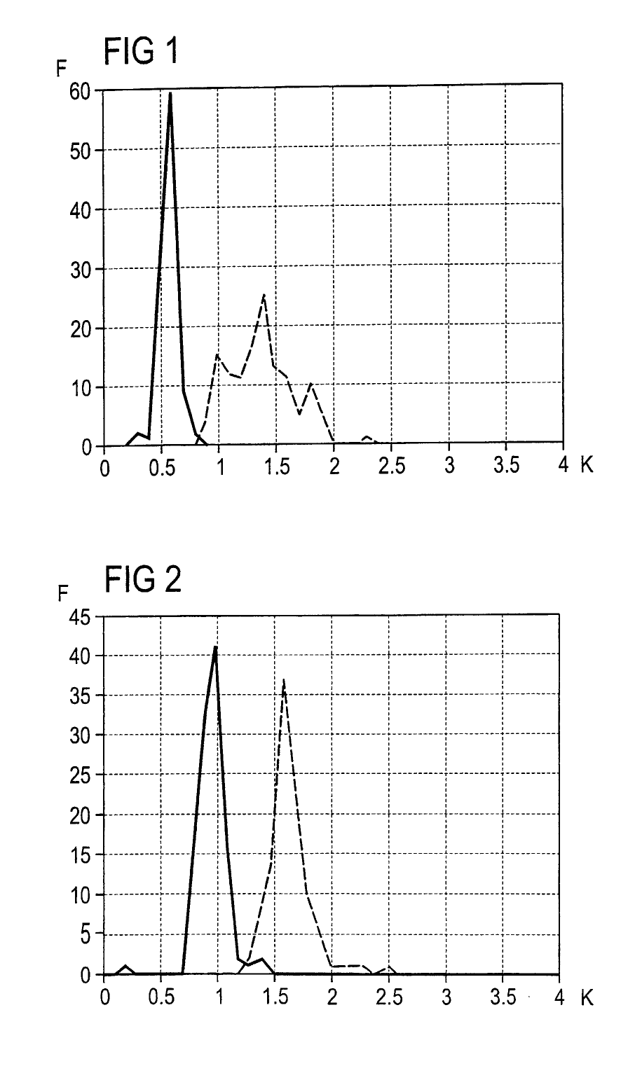

The method for scaling similarity measures by employing mean value scaling and its disadvantages are presented below with the aid of an exemplary biometry. FIGS. 1 and 2 show the cost distributions of the originals (continuous lines) and the impostors (dashed lines) for two different users in the case of this biometry. The number F is plotted in each case against the costs K. It may be seen that, depending on the user, the values of the originals and the impostors lie in different value ranges.

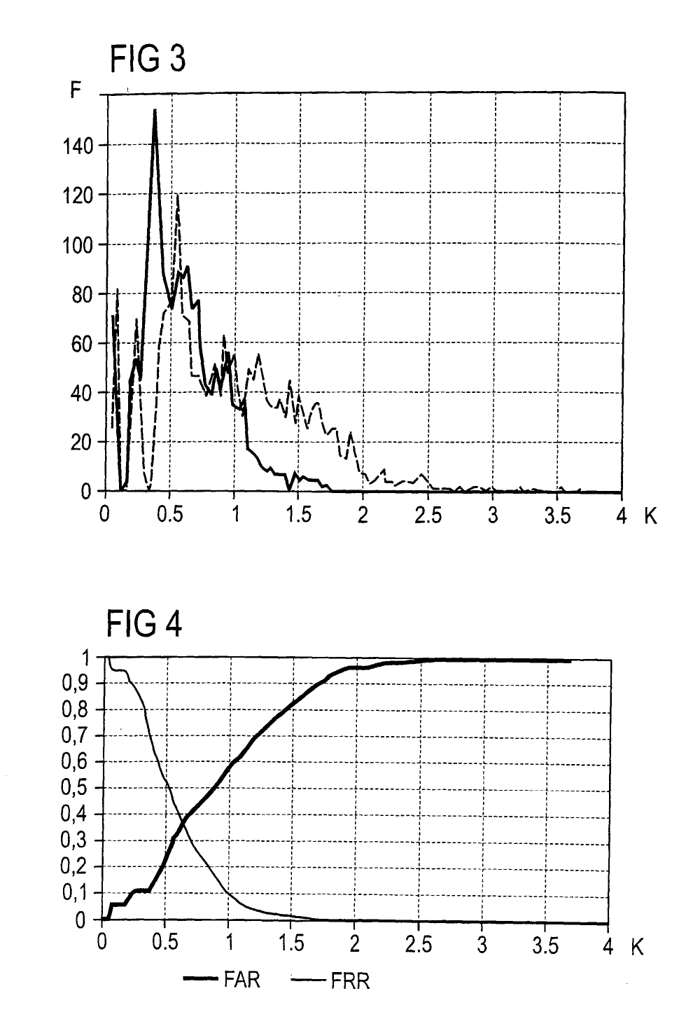

The unnormalized cost distributions of all users for originals (continuous lines) and impostors (dashed lines) and the resulting error rates (ordinate) in the case of global threshold values are illustrated for this exemplary biometry in FIGS. 3 and 4. The equal error rate (EER) without normalization is at approximately 37% in the case of the biometry investigated here.

For this exemplary biometry, the costs of the originals and those of the impostors are normalized with the aid of the various methods presented (mean value displacement, mean value displacement and scaling by standard deviation, mean value scaling). Only the costs of the originals that were used for reference formation (in the so-called enrolment) are used for the normalization. A subsequent investigation is made as to which error rates are set up after the normalization for global thresholds in the case of the various methods.

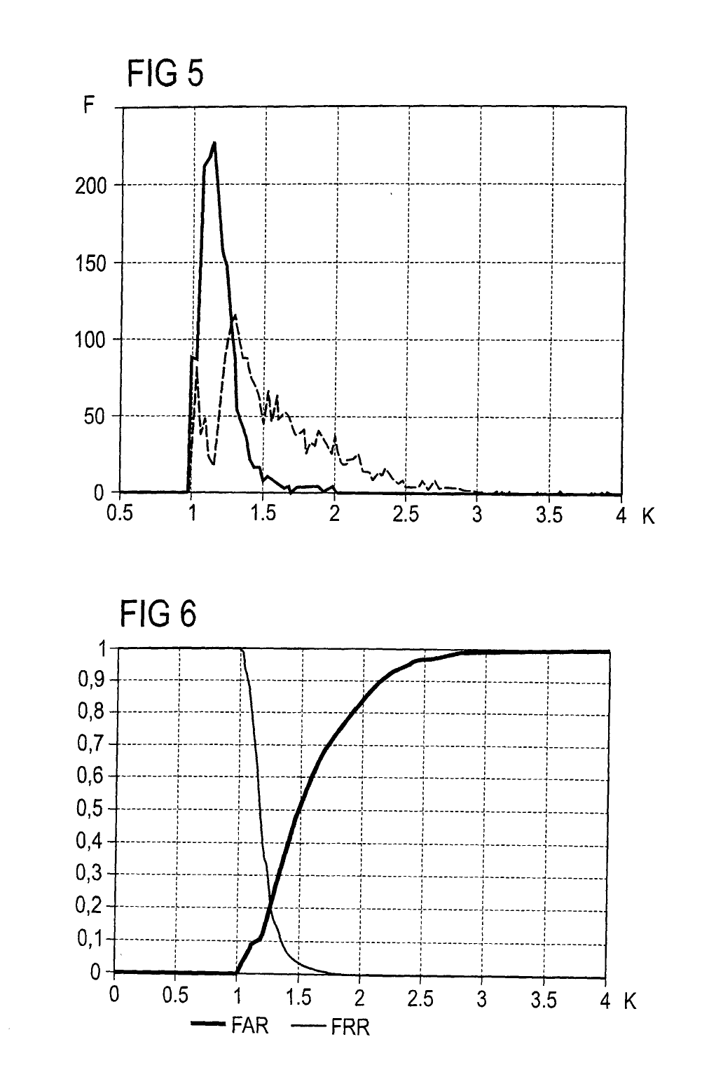

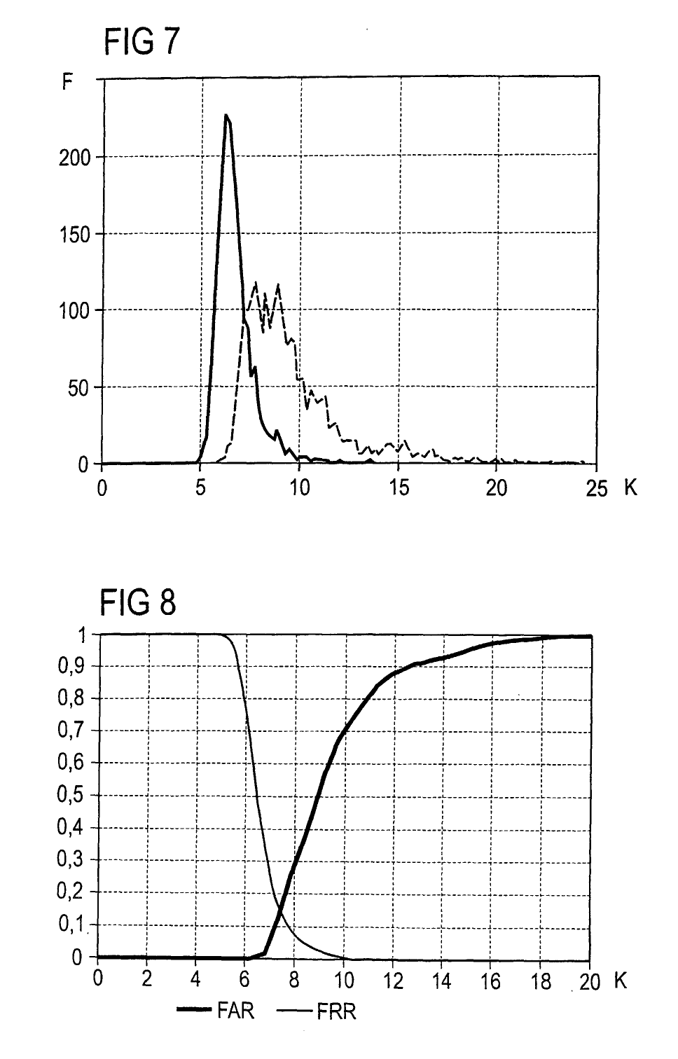

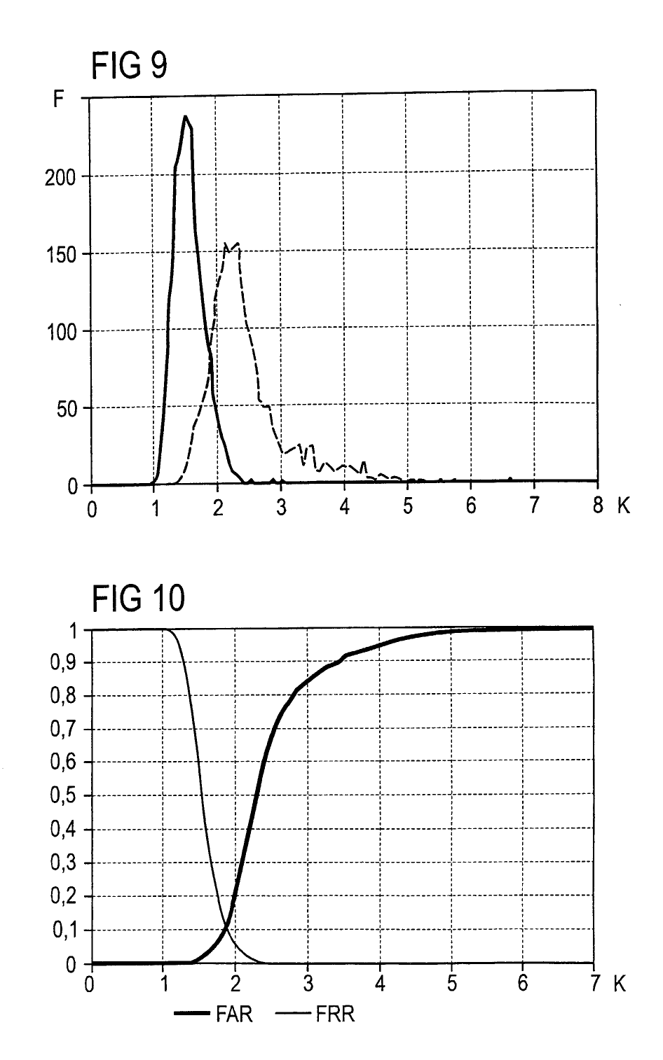

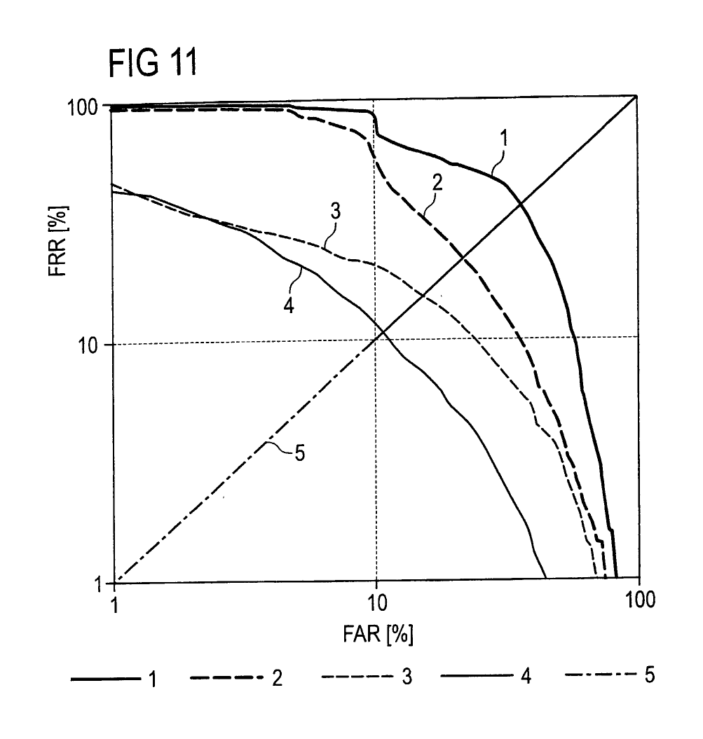

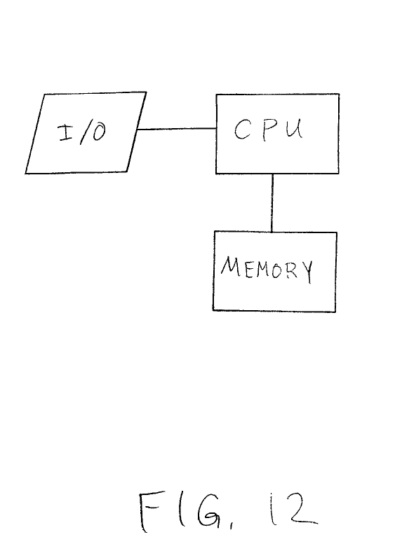

FIGS. 5 to 10 show the cost distributions of the originals and the impostors in the case of all users, and the resulting error rates as a function of global cost thresholds after normalization by the various methods.

The equal error rates EER without normalization and with the aid of the different normalization methods may be read out of the table.

| Normalization method | EER |
|---|---|
| Without normalization | 37.1% |
| Mean value displacement | 22.7% |
| Mean value displacement | 16.1% |
| and scaling with the aid of | |
| standard deviation | |
| Mean value scaling | 11.9% |

The Receiver Operating Characteristic for this case is illustrated in the following diagram 11. Here, no normalization has taken place for curve 1, normalization with the aid of mean value displacement has taken place for curve 2, normalization with the aid of mean value displacement and scaling with standard deviation has taken place for curve 3, and normalization with the aid of mean value scaling has taken place for curve 4. Curve 5 is the EER line.

All normalization methods produce a smaller EER than without normalization. The normalization, presented here, by mean value scaling produces the lowest and therefore best EER values. It is to be gathered from the ROC diagram that in the case of all FAR values this method delivers better or at least equally good FRR values as the previously used normalization methods.

The methods combining on mean value displacement and scaling by standard deviation does achieve similarly effective improvements as regards the error rates, but this method is extremely dependent on the quality of the calculated standard deviations. Possible outliners in the case of a few reference patterns, something which is regularly the case in practice, have a very much stronger effect on the standard deviations than on the mean value, and can then lead to high error rates.

The invention has been described in detail with particular reference to preferred embodiments thereof and examples, but it will be understood that variations and modifications can be effected within the spirit and scope of the invention.

What is claimed is:

1. A method for scaling similarity measures for a biometric method, the similarity measures being measures of similarity of biometric data to be compared in the biometric method, of a user with reference data of users, comprising:
scaling the similarity measures with the aid of mean value scaling.

2. The method as claimed in claim 1, further comprising normalizing the similarity measures with the aid of mean value scaling.

3. The method as claimed in claim 2, wherein the similarity measures include costs.

4. The method as claimed in claim 2, wherein the similarity measures include scores.

5. A system for scaling similarity measures for a biometric method, the similarity measures being measures of similarity of biometric data to be compared in the biometric method, of a user with reference data of users, comprising:
means for scaling the similarity measures with the aid of mean value scaling.

6. The system as claimed in claim 5, further comprising means for normalizing the similarity measures with the aid of mean value scaling.

7. The system as claimed in claim 6, wherein the similarity measures include costs.

8. The system as claimed in claim 6, wherein the similarity measures include scores.

9. At least one computer readable medium embodying at least one computer program for scaling similarity measures for a biometric method, the similarity measures being measures of similarity of biometric data to be compared in the biometric method, of a user with reference data of users, said method comprising:
scaling the similarity measures with the aid of mean value scaling.

10. The at least one computer readable medium as claimed in claim 9, further comprising means for normalizing the similarity measures with the aid of mean value scaling.

11. The at least one computer readable medium as claimed in claim 10, wherein the similarity measures include costs.

12. The at least one computer readable medium as claimed in claim 10, wherein the similarity measures include scores.

13. A system for scaling similarity measures for a biometric method, the similarity measures being measures of similarity of biometric data to be compared in the biometric method, of a user with reference data of users, comprising:
a processor to scale the similarity measures with the aid of mean value scaling.

14. The system as claimed in claim 13, wherein said processor also normalizes the similarity measures with the aid of mean value scaling.

15. The system as claimed in claim 14, wherein the similarity measures include costs.

16. The system as claimed in claim 14, wherein the similarity measures include scores.
